(19) United States
(12) Patent Application Publication
(10) Pub. No.: US 2020/0339176 A1
(43) Pub. Date: Oct. 29, 2020

(54) METHODS FOR STEERING SYSTEM IMPEDANCE CONTROL

(71) Applicant: GM Global Technology Operations LLC, Detroit, MI (US)

(72) Inventors: Yu Cao, Courtice (CA); George E. Doerr, Davisburg, MI (US); Peter J. Judis, Rochester Hills, MI (US)

(73) Assignee: GM Global Technology Operations LLC, Detroit, MI (US)

(21) Appl. No.: 16/394,377

(22) Filed: Apr. 25, 2019

(51) Int. Cl. B62D 1/183; G05D 1/00; B62D 1/187; B62D 1/181

(52) U.S. Cl. CPC B62D 1/183; G05D 1/0061; G05D 2201/0213; B62D 1/181; B62D 1/187

(57) ABSTRACT

A method for controlling a vehicle includes providing a vehicle steering system including a moveable steering column assembly and a moveable steering wheel assembly, at least one actuator coupled to the moveable steering column assembly and configured to move the vehicle steering system from a first position to a second position, providing a sensor connected to the vehicle steering system and configured to measure a steering system displacement, providing a controller electronically connected to the sensor and the at least one actuator, monitoring sensor data received from the sensor to determine a measured steering system displacement, comparing the measured steering system displacement with a tracking displacement, determining whether a condition is satisfied, and, if the condition is satisfied, automatically generating a control signal to control the at least one actuator.

### INTRODUCTION

The present disclosure relates generally to impedance control for stowable steering wheels and steering columns for vehicles controlled by automated driving systems, particularly those configured to automatically control vehicle steering, acceleration, and braking during a drive cycle without human intervention.

The operation of modern vehicles is becoming more automated, i.e. able to provide driving control with less and less driver intervention. Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

Autonomous and semi-autonomous vehicles may include a telescoping steering column to allow the steering wheel to retract away from the occupant or a foldable steering wheel, among other possible retracting mechanisms, to provide more space in the vehicle cabin.

### SUMMARY

Embodiments according to the present disclosure provide a number of advantages. For example, embodiments according to the present disclosure apply impedance control of movement of the steering wheel column during transition between a manual mode of operation and an autonomous mode of operation. The impedance control enables an improved dynamic performance in response to a triggering event (either stowing or unstowing the steering wheel and/or column) as well as enabling a smooth transition between the modes of operation.

A method for controlling a vehicle according to the present disclosure includes providing a vehicle steering system including a moveable steering column assembly and a moveable steering wheel assembly. At least one actuator is coupled to the moveable steering column assembly and the at least one actuator is configured to move the vehicle steering system from a first position to a second position. The method further includes providing a sensor connected to the vehicle steering system. The sensor is configured to measure a steering system displacement. The method also includes providing a controller electronically connected to the sensor and the at least one actuator. The controller monitors sensor data received from the sensor to determine a measured steering system displacement, compares the measured steering system displacement with a tracking displacement, determines whether a condition is satisfied, and if the condition is satisfied, automatically generates a control signal to control the at least one actuator.

In various embodiments, the condition is a first condition and the first condition is satisfied when a difference between the measured steering system displacement and the tracking displacement exceeds a reference displacement.

In various embodiments, the controller calculates a revised tracking displacement beginning when the tracking displacement exceeds the reference displacement and using a last step error of the measured steering system displacement in the calculation of the revised tracking displacement.

In various embodiments, the at least one actuator includes a first actuator and a second actuator, the first actuator is configured to translate the steering column assembly from a first steering column position to a second steering column position, and the second actuator is configured to tilt the steering column assembly from the first steering column position to the second steering column position.

In various embodiments, the first steering column position is an unstowed position and the second steering column position is a stowed position.

In various embodiments, the controller detects a trigger condition, the trigger condition including receipt, by the controller, of an input indicating a mode transition.

In various embodiments, the mode transition is a transition from a driver-controlled vehicle mode of operation to an autonomous or semi-autonomous mode of operation.

In various embodiments, the tracking displacement is a constant value prior to detection of the trigger condition.

A method for controlling a vehicle according to the present disclosure includes providing a vehicle steering system, including a moveable steering column assembly and a steering wheel assembly including a steering wheel. The moveable steering column assembly includes a first actuator coupled to the moveable steering column assembly and configured to translate the moveable steering column assembly between a stowed position and an unstowed position and a second actuator coupled to the moveable steering column assembly and configured to rotate the moveable steering column assembly between the stowed position and the unstowed position. The method further includes providing a first sensor coupled to the steering column assembly and a second sensor coupled to the steering wheel assembly. The first sensor is configured to measure a first force characteristic and the second sensor is configured to measure a second force characteristic. The method also includes providing a controller electronically connected to the first and second sensors and the first and second actuators. The controller monitors first sensor data received from the first sensor and second sensor data received from the second sensor to determine a measured steering system displacement, compares the measured steering system displacement with a tracking displacement, determines whether a condition is satisfied, and if the condition is satisfied, automatically generates a first control signal to control the first actuator and a second control signal to control the second actuator.

In various embodiments, the condition is a first condition and the first condition is satisfied when the controller determines that a push back count is less than a limit.

In various embodiments, the method further includes determining, by the controller, whether a second condition is satisfied, wherein the second condition is satisfied when a difference between the measured steering system displacement and the tracking displacement exceeds a reference displacement and, if the first and second conditions are satisfied, automatically generating the first control signal to control the first actuator and the second control signal to control the second actuator.

In various embodiments, the method further includes detecting, by the controller, a trigger condition, the trigger condition including receipt, by the controller, of an input indicating a mode transition.

In various embodiments, the mode transition is a transition from an autonomous or semi-autonomous mode of operation to a driver-controlled vehicle mode of operation.

In various embodiments, the input is sensor data from one of the first and second sensors indicating a force applied to the steering wheel of the steering wheel assembly.

In various embodiments, the method further includes determining, by the controller, whether a third condition is satisfied, wherein the third condition is satisfied when the controller determines that the steering wheel assembly is located within a steering system displacement limit distance.

In various embodiments, the method further includes determining, by the controller, whether a fourth condition is satisfied, wherein the fourth condition is satisfied when the controller determines that one of the first sensor data and second sensor data indicate operator control of the vehicle.

A vehicle steering system according to the present disclosure includes a moveable steering column assembly including a first actuator coupled to the moveable steering column assembly and configured to translate the moveable steering column assembly between a first position and a second position and a second actuator coupled to the moveable steering column assembly and configured to rotate the moveable steering column assembly between the first steering column position and the second steering column position. The vehicle steering system also includes a first sensor connected to the steering column assembly and configured to measure a first force characteristic and a second sensor connected to the steering wheel assembly and configured to measure a second force characteristic. The vehicle steering system also includes a controller electronically connected to the first and second sensors and the first and second actuators. The controller is configured to monitor first sensor data received from the first sensor and second sensor data received from the second sensor to determine a measured steering system displacement, compare the measured steering system displacement with a tracking displacement, calculate a revised tracking displacement based on the measured steering system displacement using impedance control, determine whether a condition is satisfied, and if the condition is satisfied, automatically generate a first control signal to control the first actuator and a second control signal to control the second actuator.

In various embodiments, the controller is further configured to detect a trigger condition, the trigger condition including receipt, by the controller, of an input indicating a mode transition.

In various embodiments, the mode transition is a transition from a driver-controlled vehicle mode of operation to an autonomous or semi-autonomous mode of operation.

In various embodiments, the condition is a first condition and the first condition is satisfied when a difference between the measured steering system displacement and the tracking displacement exceeds a reference displacement and calculating the revised tracking displacement based on the measured steering system displacement using impedance control includes using a last step error of the measured steering system displacement in the calculation of the revised tracking displacement.

### BRIEF DESCRIPTION OF THE DRAWINGS

The present disclosure will be described in conjunction with the following figures, wherein like numerals denote like elements.

FIG. 1 is a schematic diagram of a vehicle, according to an embodiment.

FIG. 2 is a schematic diagram of a moveable steering system of a vehicle, according to an embodiment.

FIG. 3 is a flow diagram of a method to control a vehicle, specifically a moveable steering system of a vehicle, according to an embodiment.

FIG. 4 is a graphical representation of the displacement of a moveable steering system, according to an embodiment.

FIG. 5 is a flow diagram of a method to control a vehicle, specifically a moveable steering system of a vehicle, according to an embodiment.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above derivatives thereof, and words of similar import.

Autonomous and semi-autonomous vehicles may include a telescoping steering column or shaft that allows the steering wheel to be stowed within the dashboard when not in use to increase the amount of usable space within the passenger compartment. The methods and systems discussed herein detect a triggering event for transfer stowing and/or unstowing and/or folding operation of the steering column and incorporate control system responses to stop/reverse/pause/etc. the translational motion of the steering column assembly to smoothly transition between vehicle operational modes.

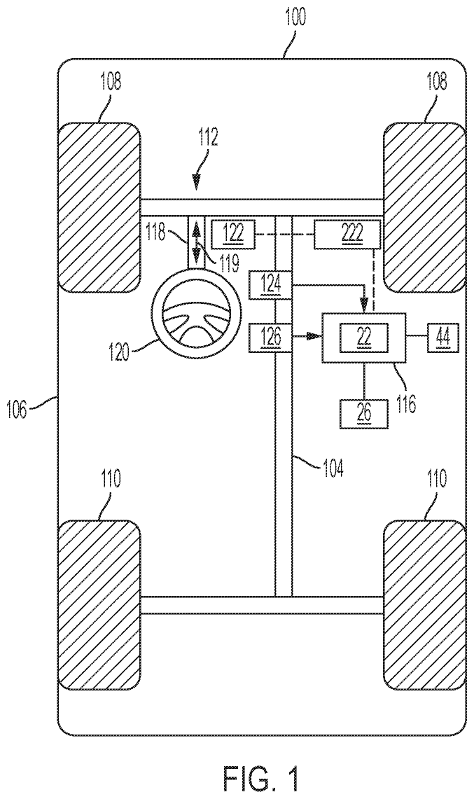

With reference to FIG. 1, a vehicle 100 is shown that includes a steering system 112 in accordance with various embodiments. Although the figures shown herein depict an example with certain arrangements of elements, additional intervening elements, devices, features, or components may be present in an actual embodiment. It should also be understood that FIG. 1 is merely illustrative and may not be drawn to scale.

As depicted in FIG. 1, the vehicle 100 generally includes a chassis 104, a body 106, front wheels 108, rear wheels 110, a steering system 112, and a control system 116. The body 106 is arranged on the chassis 104 and substantially encloses the other components of the vehicle 100. The body 106 and the chassis 104 may jointly form a frame. The wheels 108, 110 are each rotationally coupled to the chassis 104 near a respective corner of the body 106.

As can be appreciated, the vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD). The vehicle 100 may also incorporate any one of, or combination of, a number of different types of propulsion systems, such as, for example, a gasoline or diesel fueled combustion engine, a “flex fuel vehicle” (FFV) engine (i.e., using a mixture of gasoline and ethanol), a gaseous compound (e.g., hydrogen or natural gas) fueled engine, a combustion/electric motor hybrid engine, and an electric motor.

In some embodiments, the vehicle 100 is an autonomous or semi-autonomous vehicle. The vehicle 100, in some embodiments, incorporates various automated driver-assistance systems, such as cruise control, adaptive cruise control, and parking assistance systems correspond to lower automation levels, while true “driverless” vehicles correspond to higher automation levels. In some embodiments, the vehicle 100 includes a stowable steering system 112 that may be stowed within the vehicle console when desired by the vehicle operator or occupant to obtain greater space within the passenger compartment.

In some embodiments, the steering system 112 includes a steering column assembly 118 and a steering wheel assembly 120. The steering column assembly 118 can be a collapsible assembly such that the steering column assembly 118 and the steering wheel assembly 120 can translate axially from a first, or unstowed, position to a second, or stowed, position, or any intermediate position between an unstowed or stowed position, as indicated by the arrow 119. In various embodiments, the steering system 112 is a steer-by-wire system that makes use of electric motors to provide steering assist, sensors to measure steering wheel angle and torque applied by the operator, and a steering wheel emulator to provide torque feedback to the driver. In some embodiments, the steering wheel assembly 120 includes a foldable steering wheel that folds to a smaller profile for easier storage when the steering wheel assembly 120 is in the stowed position.

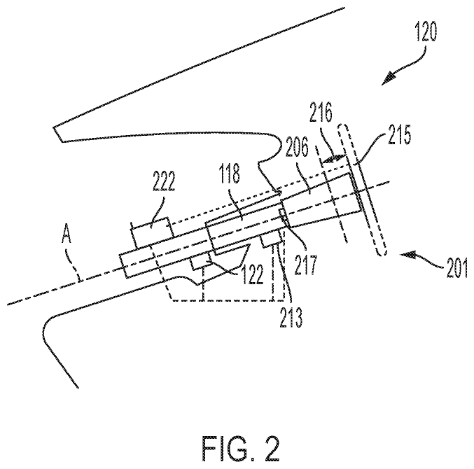

In various embodiments, the steering system 112 includes at least one motor or actuator coupled to the steering column assembly 118 (one telescoping actuator 122 is shown in FIG. 1). In some embodiments, the telescoping actuator 122 can be coupled to the rotatable shaft of the steering column assembly 118 to enable telescoping functionality of the steering column assembly 118. In some embodiments, one or more actuators may be coupled to the steering column assembly 118, with a first actuator or motor providing force to the road wheels 108 and a second motor or actuator enabling telescoping functionality of the steering column assembly 118 along a longitudinal axis A of the steering column assembly (see FIG. 2). The telescoping actuator 122 moves the steering column assembly between a first steering column position and a second steering column position. As discussed herein, operation of the one or more motors can be monitored and controlled by the control system 116 to determine if an overload and/or pinch condition exists.

The steering system 112 further includes one or more sensors that sense observable conditions of the steering system 112. In various embodiments, the steering system 112 includes a torque sensor 124 and a steering angle sensor 126. The torque sensor 124 senses a rotational torque applied to the steering system by for example, a driver of the vehicle 100 via the steering wheel assembly 120 and generates torque signals based thereon. The steering angle sensor 126 senses a rotational position of the steering wheel 120 and generates position signals based thereon.

With further reference to FIG. 1, the vehicle 100 also includes a plurality of sensors 26 configured to measure and capture data on one or more vehicle characteristics, including but not limited to vehicle speed, vehicle heading, throttle position, ignition status, displacement of a retractable steering column, position of a foldable steering wheel member, etc. The sensors 26 are electronically connected to the control system 116 and provide data on vehicle characteristics and operating conditions. In the illustrated embodiment, the sensors 26 include, but are not limited to, an accelerometer, a position sensor, a speed sensor, a heading sensor, gyroscope, steering angle sensor, or other sensors that sense observable conditions of the vehicle or the environment surrounding the vehicle and may include RADAR, LIDAR, optical cameras, thermal cameras, ultrasonic sensors, infrared sensors, pressures sensors, contact sensors, and/or additional sensors as appropriate.

The control system 116 includes a controller 22. While depicted as a single unit for illustrative purposes, the controller 22 may additionally include one or more other controllers, collectively referred to as a “controller.” The control system 116 receives the sensor signals and monitors and/or controls operation of the steering system 112 based thereon. In general, the control system 116 receives the sensor signals, and processes the sensor signals over a certain time period to calculate the new desired output displacement based on the feedback force and a pre-set reference model to estimate an interference force, for example and without limitation. In some embodiments, the control system 116 is coupled to the steering column assembly 118.

FIG. 2 illustrates a steering wheel assembly 120, according to an exemplary embodiment. The steering wheel assembly 120 includes a stowable and foldable steering wheel 201. The stowable and foldable steering wheel 201 is acted on by one or more actuators to translate between a first, or unstowed, position and a second, or stowed, position, including any intermediate position therebetween. In some embodiments, a pivot action actuator 213 is positioned within or adjacent to the shroud assembly 206. The actuator 213 acts to pivot the steering wheel 201 between the first position and the second position. In various embodiments, the steering wheel 201 is moved between the first and second positions via both translation and pivoting actions. In various embodiments, the steering wheel 201 is moved between the first and second positions via one of translation and pivoting actions.

With continued reference to FIG. 2, the pivot action actuator 213 and the telescoping actuator 122 are each electrically connected, via a wired or wireless connection, to a controller 222. In some embodiments, the controller 222 is a steering column controller and is one component of, or electrically connected to, the control system 116. While depicted as a single unit for illustrative purposes, the controller 222 may additionally include one or more other controllers, collectively referred to as a “controller.”

The controller 22 and the controller 222 may include a microprocessor or central processing unit (CPU) or graphical processing unit (GPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 and the controller 222 in controlling the vehicle. As shown in FIG. 1, the controller 222 is, in some embodiments, electrically connected via a wired or wireless connection to the controller 22. In some embodiments, the controllers 22, 222 provide autonomous vehicle control to the vehicle 100.

In addition to the other sensors 26 of the vehicle 100, in some embodiments, the steering wheel assembly 120 includes a steering wheel force sensor 215 and the steering column assembly 118 includes a steering shaft force sensor 217, as shown in FIG. 2. Each of the sensors 215, 217 are electrically connected, via a wired or wireless connection, to the controller 222. The steering wheel force sensor 215 provides data regarding a pinch or impedance force detected when the steering wheel 201 pivots to the stowed position, for example and without limitation. The steering shaft force sensor 217 provides data regarding detection of a force applied to the steering wheel assembly 120 or the column assembly 118, such as, for example and without limitation, a pinch force, pressure applied to the steering wheel by a vehicle occupant, etc. In response to detection of a hands-off or hands-free steering condition, the controller 222 may initiate a folding and/or stowing operation. In response to detection of a pinch force, the controller 222 may terminate a stowing and/or folding operation.

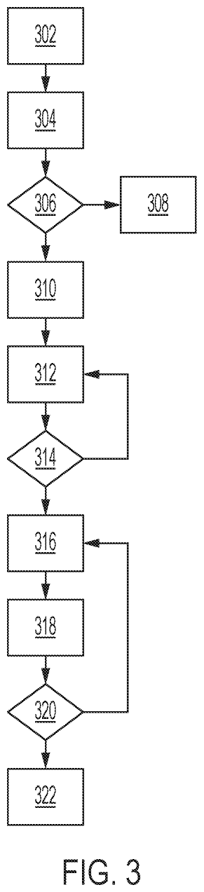

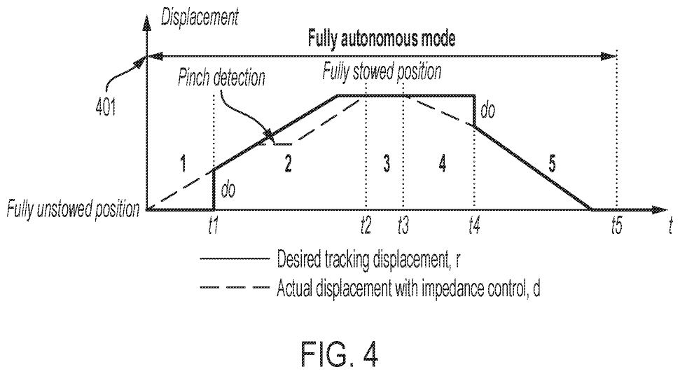

FIG. 3 illustrates a method 300 to control the motion of a retractable and/or tiltable and/or foldable steering system 112 using impedance control, specifically a stowing operation during a transition from an operator-controlled mode of operation to an autonomous or semi-autonomous mode of operation. FIG. 4 is a schematic diagram illustrating the displacement of the steering system 112 over time with various stages of displacement outlined. As is well known, impedance control is a feedback control method designed to control dynamic interaction between a manipulator, such as a retractable, tiltable, and foldable steering system 112, and its environment. The method 300 can be utilized in connection with the steering system 112, the control system 116, and the various sensors 26, 215, 217. The method 300 can be utilized in connection with the controller 22 and/or the controller 222, as discussed herein, or by other systems associated with or separate from the vehicle, in accordance with exemplary embodiments. The order of operation of the method 300 is not limited to the sequential execution as illustrated in FIG. 3, but may be performed in one or more varying orders, or steps may be performed simultaneously, as applicable in accordance with the present disclosure.

The method 300 begins at 302 when a trigger condition is detected. The trigger condition is, in some embodiments, receipt by the controller of an operator input indicating a mode transition. The mode transition is a transition from a driver-controlled vehicle mode of operation to an autonomous or semi-autonomous mode of operation. In various embodiments, the operator input is engagement of a button, switch, toggle, or any other tactile input that may be received by the controller. In some embodiments, the operator input is an auditory command received by a sensor coupled to the controller.

As shown in FIG. 4, receipt of an operator input indicating a mode transition from the driver-controlled vehicle mode of operation to an autonomous or semi-autonomous mode of operation occurs at 401 and initiates the displacement of the steering system 112 over time.

Next, at 304, the controller initiates the transition from the driver-controlled vehicle mode of operation to an autonomous or semi-autonomous mode of operation.

At 306, the controller confirms a first condition is satisfied. In some embodiments, the first condition is satisfied when an autonomous or semi-autonomous mode of operation is selected and available, given the current vehicle and/or environmental conditions. These conditions may include data regarding the vehicle environment or the vehicle operating condition received from one or more vehicle sensors. If the first condition is not satisfied, that is, an autonomous or semi-autonomous mode of operation is not confirmed and/or is not available due to current conditions, the method 300 proceeds to 308 and the operator retains control of the vehicle. The controller does not retract and/or fold the steering system 112.

However, if the first condition is satisfied, that is, an autonomous or semi-autonomous mode of operation is confirmed and/or is available, the method 300 proceeds to 310. At 310, the controller initiates impedance control of the stowing action(s), as discussed in greater detail below.

Next, at 312, the controller receives data regarding force applied to the steering wheel 201. In various embodiments, the force applied to the steering wheel 201 is a pushing force, that is, the occupant exerts a force on the steering wheel to push it toward the stowed position. The controller registers the force applied by the occupant on the steering wheel 201 and receives an actual, measured, displacement feedback d, from one or more sensors. The force applied to the steering wheel 201 may be received from the steering wheel force sensor 215, for example. The actual displacement feedback d is the actual and measured displacement of the steering system component, such as, for example and without limitation, the axial translation of the steering column assembly 118 and/or the degree of rake or tilt of the steering column assembly 118. As shown in FIG. 2, a distance 216 defines a steering system displacement limit. Actual displacement feedback d within the distance 216 is a permitted variation in steering system displacement and the controller permits occupant control of steering while the actual displacement is within the permitted variation. In other words, displacement of the steering system within the distance 216 is within expected normal adjustment of the steering system position to a position desired by the occupant. In various embodiments, the steering system displacement limit distance 216 is a linear distance along the longitudinal axis A of the steering column assembly 118.

The controller determines whether a second condition is satisfied at 314. In some embodiments, the second condition is whether a difference between the actual displacement feedback d and a desired tracking displacement r is greater than a reference or expected displacement d₀. Prior to initiation of a mode transfer operation such as stowing or unstowing operations, the controller determines the desired tracking displacement r. Depending on the mode transfer operation (from operator-controlled to autonomous or semi-autonomous or vice versa), the desired tracking displacement r is a constant value when the steering system is fully stowed and fully unstowed. The value of the desired tracking displacement r of the steering system may be different depending on the initial mode of the mode transfer operation. If the second condition is not satisfied, that is, the difference is not greater than the expected displacement d₀, the method 300 returns to 312.

If the second condition is satisfied, that is, the displacement feedback indicates that the steering system has been displaced a difference greater than the reference displacement d₀, the method 300 proceeds to 316. On FIG. 4, Stage 1 graphically displays the displacement of the steering system over time during this phase of the mode transition.

Next, at 316, the controller triggers the stowing operation of the steering system. As discussed herein, stowing operations include one more of translating the steering column, folding the steering wheel, and adjusting a tilt or rake of the steering column. The stowing operation is triggered at a time t₁ and proceeds through time t₂, as shown in FIG. 4 as Stage 2. The controller generates one or more control signals and transmits the control signals to the actuators 122, 213 to fold the steering wheel assembly 120 and/or axially translate or retract the steering column assembly 118 and/or adjust a tilt or rake of the steering column assembly 118.

If the steering system has been displaced a difference greater than the reference displacement d₀, the desired tracking displacement r is reset, starting from the last measurement prior to the trigger condition. For various times during the mode transition:

At t(k)=t₁,r(k)=0,d(k)=d₀,error(k)=d₀; EQUATION 1

At t(k+1),r(k+1)=d₀; EQUATION 2

Calculation of the control output r(k+1) for t(k+1) relies on the last step error error(k). In traditional discrete control systems, a zero (0) initial error condition is assumed, which indicates error(0)=0. When the error(0) is not zero, the initial value of the error might lead to an oscillation of the calculated control output which will be dissipated by the system damping or even a divergent control. To reduce the chance of a potential stability issue at the jump point, the error(k) is reset to 0 (zero).

During this stage of operation, the controller, at 318, performs the stowing operation using impedance control as discussed herein and pinch detection, as discussed in greater detail in U.S. patent application Ser. No. 16/176,586, filed on Oct. 31, 2018, titled METHODS FOR STEERING SYSTEM IMPEDANCE CONTROL, incorporated by reference herein.

Next, at 320, the controller determines whether a third condition is satisfied. In some embodiments, the third condition is satisfied when the controller determines that the steering system has reached the second, or stowed, position. If the third condition is not satisfied, that is, the steering system is not in the second position, the method 300 returns to 316 and proceeds as discussed herein. In various embodiments, the controller initiates and/or increases by one a count indicating the number of times the controller has received data indicating a pushing force was applied to the steering wheel by the occupant, otherwise known as a push back count.

However, if the third condition is satisfied, that is, the steering system has reached the second or stowed position, the method 300 proceeds to 322. At 322, the controller disengages impedance control of the stowing operation. In various embodiments, impedance control of the rake adjustment of the steering system is disengaged separately from impedance control of the translation and/or folding operations. This mode of operation is graphically illustrated in FIG. 4 as Stage 3, between times t₂ and t₃. The desired tracking displacement r is reset to a predetermined constant value.

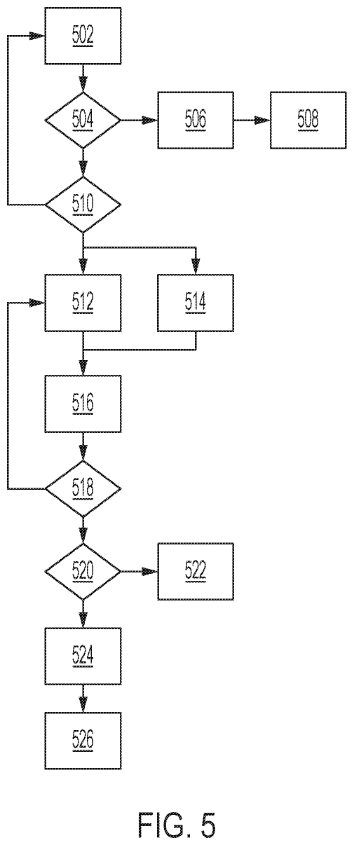

FIG. 5 illustrates a method 500 to control the motion of a retractable and/or tiltable and/or foldable steering system 112 using impedance control, specifically an unstowing operation during a transition from an autonomous or semi-autonomous mode of operation to an operator-controlled mode of operation. The method 500 can be utilized in connection with the steering system 112, the control system 116, and the various sensors 26, 215, 217. The method 500 can be utilized in connection with the controller 22 and/or the controller 222, as discussed herein, or by other systems associated with or separate from the vehicle, in accordance with exemplary embodiments. The order of operation of the method 500 is not limited to the sequential execution as illustrated in FIG. 5, but may be performed in one or more varying orders, or steps may be performed simultaneously, as applicable in accordance with the present disclosure.

The method 500 beings at 502 when a trigger condition is detected. In various embodiments, the trigger condition is received by the controller of data regarding force applied to the steering wheel 201. The force applied to the steering wheel is a pulling force, that is, the occupant exerts force on the steering wheel to pull it away from the stowed position. The pulling force is a trigger condition indicating a mode transfer request that the occupant desires to transition the mode of operation from an autonomous or semi-autonomous mode of operation to an operator-controlled mode of operation.

Next, at 504, the controller determines whether a first condition is satisfied. In some embodiments, the first condition is satisfied when the push back count is greater than a predetermined limit. In various embodiments, the predetermined limit is 3 (three). In other embodiments, the predetermined limit is greater than or less than 3.

If the first condition is not satisfied, that is, the push back count is greater than the predetermined limit, the method 500 continues to 506. At 506, the controller rejects the mode transfer request and maintains operation of the vehicle in the autonomous or semi-autonomous mode of operation. In various embodiments, at 508, the controller generates a message, such as a warning message, and transmits this message to an audio and/or video device 44 coupled to the controller 22 and/or the controller 222.

If the first condition is satisfied, that is, the push back count is equal to or less than the predetermined limit, the method 500 proceeds to 510. At 510, the controller determines whether a second condition is satisfied. In some embodiments, the second condition is whether a difference between the actual displacement feedback d and a desired tracking displacement r is greater than a reference or expected displacement d₀. If the second condition is not satisfied, that is, the difference is not greater than the expected displacement d₀, the method 500 returns to 502.

If the second condition is satisfied, that is, the displacement feedback indicates that the steering system has been displaced a difference greater than the reference displacement d₀, the method 500 proceeds to 512. In various embodiments, the method 500 also proceeds to 514 which may be performed simultaneously as the actions performed at 512 or may be performed sequentially with the actions performed at 512. On FIG. 4, Stage 4 graphically displays the displacement of the steering system between times t₃ and t₄ during this phase of the mode transition.

Next, at 512, the controller triggers the unstowing operation of the steering system. As discussed herein, unstowing operations include one more of translating the steering column, folding the steering wheel, and adjusting a tilt or rake of the steering column. The unstowing operation is triggered at time t₃ and proceeds through time t₅, as shown in FIG. 4 as Stages 4 and 5. The controller generates one or more control signals and transmits the control signals to the actuators 122, 213 to unfold the steering wheel assembly 120 and/or axially translate or extend the steering column assembly 118 and/or adjust a tilt or rake of the steering column assembly 118. At 514, the controller engages impedance control of the raking action(s).

During this stage of operation, the controller, at 516, performs the unstowing operation using impedance control and pinch detection, similarly as performed above with reference to step 318 of the method 300.

Next, at 518, the controller determines whether a third condition is satisfied. In some embodiments, the third condition is satisfied when the controller determines that permission is granted for operator-controlled operation of the vehicle. This is determined by identifying whether the steering wheel 201 of the steering wheel assembly 120 is located within the steering system displacement limit distance 216. When push and/or pull actions on the steering wheel 201 result in movement within the steering system displacement limit distance 216, the controller determines that these actions indicate an operator intent to control the vehicle and the controller allows operator control. If the third condition is not satisfied, that is, permission is not granted for operator-controlled operation, the method 500 returns to 512.

If the third condition is satisfied, that is, the controller determines that permission is granted for operator-controlled operation, the method 500 proceeds to 520. At 520, the controller determines whether a fourth condition is satisfied. In various embodiments, the fourth condition is satisfied when the controller receives data indicating that the operator has assumed control of the vehicle steering by, for example and without limitation, grasping the steering wheel 201 as detected by the steering wheel force sensors 215, pulling the steering wheel 201, and/or pushing the steering wheel 201. If the operator pushes the steering wheel 201, the method proceeds to 522. At 522, the push back count increases by 1 (one).

If the fourth condition is satisfied, that is, the data received by the controller indicates that the operator has assumed control of the vehicle steering, the method 500 proceeds to 524. At 524, the controller performs various operations to confirm the operator is available and ready to assume operation of the vehicle steering. In some embodiments, the operations include receiving data regarding a grip force on the steering wheel 201, visual data of operator's position in the vehicle, eye tracking, etc. for example and without limitation.

Next, at 526, the controller disengages impedance control of the unstowing operations, including rake and translation control of the steering column assembly 118. The transfer to the operator-controlled mode of operation is considered complete and the controller terminates autonomous or semi-autonomous control of vehicle steering.

It should be emphasized that many variations and modifications may be made to the herein-described embodiments the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, hut may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation.

What is claimed is:

1. A method for controlling a vehicle, the method comprising:
providing a vehicle steering system, the vehicle steering system comprising a moveable steering column assembly and a moveable steering wheel assembly, at least one actuator coupled to the moveable steering column assembly, the at least one actuator configured to move the vehicle steering system from a first position to a second position;
providing a sensor connected to the vehicle steering system, the sensor configured to measure a steering system displacement;
providing a controller electronically connected to the sensor and the at least one actuator;
monitoring, by the controller, sensor data received from the sensor to determine a measured steering system displacement;
comparing, by the controller, the measured steering system displacement with a tracking displacement;
determining, by the controller, whether a condition is satisfied; and
if the condition is satisfied, automatically generating, by the controller, a control signal to control the at least one actuator.

2. The method of claim 1, wherein the condition is a first condition and the first condition is satisfied when a difference between the measured steering system displacement and the tracking displacement exceeds a reference displacement.

3. The method of claim 2, wherein the controller calculates a revised tracking displacement beginning when the tracking displacement exceeds the reference displacement and using a last step error of the measured steering system displacement in the calculation of the revised tracking displacement.

4. The method of claim 1, wherein the at least one actuator includes a first actuator and a second actuator, the first actuator is configured to translate the steering column assembly from a first steering column position to a second steering column position, and the second actuator is configured to tilt the steering column assembly from the first steering column position to the second steering column position.

5. The method of claim 4, wherein the first steering column position is an unstowed position and the second steering column position is a stowed position.

6. The method of claim 1 further comprising detecting, by the controller, a trigger condition, the trigger condition comprising receipt, by the controller, of an input indicating a mode transition.

7. The method of claim 6, wherein the mode transition is a transition from a driver-controlled vehicle mode of operation to an autonomous or semi-autonomous mode of operation.

8. The method of claim 6, wherein the tracking displacement is a constant value prior to detection of the trigger condition.

9. A method for controlling a vehicle, the method comprising:
providing a vehicle steering system, the vehicle steering system comprising a moveable steering column assembly and a steering wheel assembly comprising a steering wheel, the moveable steering column assembly including a first actuator coupled to the moveable steering column assembly and configured to translate the moveable steering column assembly between a stowed position and an unstowed position and a second actuator coupled to the moveable steering column assembly and configured to rotate the moveable steering column assembly between the stowed position and the unstowed position;
providing a first sensor coupled to the steering column assembly and a second sensor coupled to the steering wheel assembly, the first sensor configured to measure a first force characteristic and the second sensor configured to measure a second force characteristic;
providing a controller electronically connected to the first and second sensors and the first and second actuators;
monitoring, by the controller, first sensor data received from the first sensor and second sensor data received from the second sensor to determine a measured steering system displacement;
comparing, by the controller, the measured steering system displacement with a tracking displacement;
determining, by the controller, whether a condition is satisfied; and
if the condition is satisfied, automatically generating, by the controller, a first control signal to control the first actuator and a second control signal to control the second actuator.

10. The method of claim 9, wherein the condition is a first condition and the first condition is satisfied when the controller determines that a push back count is less than a limit.

11. The method of claim 10 further comprising determining, by the controller, whether a second condition is satisfied, wherein the second condition is satisfied when a difference between the measured steering system displacement and the tracking displacement exceeds a reference displacement and, if the first and second conditions are satisfied, automatically generating the first control signal to control the first actuator and the second control signal to control the second actuator.

12. The method of claim 9 further comprising detecting, by the controller, a trigger condition, the trigger condition comprising receipt, by the controller, of an input indicating a mode transition.

13. The method of claim 12, wherein the mode transition is a transition from an autonomous or semi-autonomous mode of operation to a driver-controlled vehicle mode of operation.

14. The method of claim 12, wherein the input is sensor data from one of the first and second sensors indicating a force applied to the steering wheel of the steering wheel assembly.

15. The method of claim 11 further comprising determining, by the controller, whether a third condition is satisfied, wherein the third condition is satisfied when the controller determines that the steering wheel assembly is located within a steering system displacement limit distance.

16. The method of claim 15 further comprising determining, by the controller, whether a fourth condition is satisfied, wherein the fourth condition is satisfied when the controller determines that one of the first sensor data and second sensor data indicate operator control of the vehicle.

17. A vehicle steering system, comprising:
a moveable steering column assembly, the moveable steering column assembly comprising a first actuator coupled to the moveable steering column assembly and configured to translate the moveable steering column assembly between a first position and a second position and a second actuator coupled to the moveable steering column assembly and configured to rotate the moveable steering column assembly between the first steering column position and the second steering column position;
a first sensor connected to the steering column assembly, the first sensor configured to measure a first force characteristic;
a second sensor connected to the steering column assembly, the second sensor configured to measure a second force characteristic;
a controller electronically connected to the first and second sensors and the first and second actuators, the controller configured to
monitor first sensor data received from the first sensor and second sensor data received from the second sensor to determine a measured steering system displacement;
compare the measured steering system displacement with a tracking displacement;
calculate a revised tracking displacement based on the measured steering system displacement using impedance control;
determine whether a condition is satisfied; and
if the condition is satisfied, automatically generate a first control signal to control the first actuator and a second control signal to control the second actuator.

18. The vehicle steering system of claim 17, wherein the controller is further configured to detect a trigger condition, the trigger condition comprising receipt, by the controller, of an input indicating a mode transition.

19. The vehicle steering system of claim 18, wherein the mode transition is a transition from a driver-controlled vehicle mode of operation to an autonomous or semi-autonomous mode of operation.

20. The vehicle steering system of claim 17, wherein the condition is a first condition and the first condition is satisfied when a difference between the measured steering system displacement and the tracking displacement exceeds a reference displacement and calculating the revised tracking displacement based on the measured steering system displacement using impedance control comprises using a last step error of the measured steering system displacement in the calculation of the revised tracking displacement.
